(19) United States
(12) Patent Application Publication
(10) Pub. No.: US 2024/0359643 A1
(43) Pub. Date: Oct. 31, 2024

(54) PROTECTOR

(71) Applicant: YAZAKI CORPORATION, Tokyo (JP)

(72) Inventor: Akitoshi KIMURA, Aichi (JP)

(73) Assignee: YAZAKI CORPORATION, Tokyo (JP)

(21) Appl. No.: 18/641,715

(22) Filed: Apr. 22, 2024

(30) Foreign Application Priority Data
Apr. 26, 2023 (JP) 2023-072095

(51) Int. Cl. B60R 16/02; H02G 3/04

(52) U.S. Cl. CPC B60R 16/0215; H02G 3/0475; H02G 3/0481

(57) ABSTRACT

A protector includes: a first cylindrical body having a first body and a first cover which is attached to the first body in a first attachment direction; and a second cylindrical body having a second body and a second cover which is attached to the second body in a second attachment direction. One end of the first cylindrical body is an inner cylindrical part, and one end of the second cylindrical body is an outer cylindrical part. A rotation angle of the inner cylindrical part changes between a first angle in which the first attachment direction is in a same position as the second attachment direction and a second angle in which the first attachment direction is not in a same position as the second attachment direction and which is in a posture when the first cylindrical part and the second cylindrical part are assembled to the vehicle.

### CROSS-REFERENCE TO RELATED APPLICATION

The present application is based on, and claims priority from the Japanese Patent Application No. 2023-072095, filed on Apr. 26, 2023, the entire contents of which are incorporated herein by reference.

### TECHNICAL FIELD

The disclosure relates to a protector.

### BACKGROUND

Conventionally, protectors have been known which store and protect wire harnesses which are routed in the interior of vehicles such as automobiles. JP 2014-138481 A discloses a technology for a protector including a first protector as a first cylindrical body and a second protector as a second cylindrical body. Since the extension direction of the routing path to be laid differs in three dimensions between the first protector and the second protector, the overall shape at the time of vehicle assembly becomes a so-called three-dimensional shape.

### SUMMARY OF THE INVENTION

In the protector disclosed in JP 2014-138481 A, the first protector is laid on the side panel of the vehicle interior, and the second protector is laid on the floor panel adjacent to the side panel, and thus the three-dimensional shape at the time of vehicle assembly is simple. However, in some cases, a protector having a three-dimensional shape is not only simple, but also has a plurality of cylindrical bodies each of which has a complicated extension direction due to various requirements, which are required on the vehicle side, such as the shape, the mold formability, the mold cost, or the routing workability of the wire harness, or the like. In such cases, the attachment direction of a cover differs greatly for each cylindrical body. For this reason, in the routing of the wire harness to the protector before the vehicle assembly, it may be necessary for workers to remove a cover for each cylindrical body, and perform dimensioning after each of the cylindrical bodies is supported again by an individual jig suitable for the routing. Therefore, there is a difficulty in the routing workability until the protector to which the wire harness is routed has a final three-dimensional shape.

An object of the present disclosure is to provide a protector which improves the routing workability of wire harnesses in a case where a three-dimensional shape is obtained at the time of vehicle assembly.

A protector according to some embodiments assembled to a vehicle in a state in which a wire harness is penetrated, and the protector includes: a first cylindrical body having a first body which stores a portion of the wire harness in a first region over an entire extension direction and a first cover which is attached to the first body in a first attachment direction so as to cover the first region; and a second cylindrical body having a second body which at least stores a portion of the wire harness which is not stored in the first cylindrical body in a second region over an entire extension direction and a second cover which is attached to the second body in a second attachment direction so as to cover the second region, in which one end of the first cylindrical body in the extension direction is an inner cylindrical part formed into a cylindrical shape, one end of the second cylindrical body in the extension direction is an outer cylindrical part which rotates the inner cylindrical part around an axis while holding the inner cylindrical part at an inner side thereof, and a rotation angle of the inner cylindrical part changes between a first angle in which the first attachment direction is in a same position as the second attachment direction and a second angle in which the first attachment direction is not in a same position as the second attachment direction and which is in a posture when the first cylindrical part and the second cylindrical part are assembled to the vehicle.

According to the above configuration, it is possible to provide a protector that improves the routing workability of wire harnesses in a case where a three-dimensional shape is obtained at the time of vehicle assembly.

### BRIEF DESCRIPTION OF DRAWINGS

FIG. 1A is a perspective view of a protector according to a first embodiment.

FIG. 1B is a perspective view illustrating a rear side of the protector illustrated in FIG. 1A.

FIG. 2 is a perspective view of the protector at the time of routing according to the first embodiment.

FIG. 3 is a perspective view of the protector at the time of vehicle assembly according to the first embodiment.

FIG. 4A is a perspective view of a cylindrical body coupling part at the time of routing in the first embodiment.

FIG. 4B is a perspective view of the cylindrical body coupling part at the time of vehicle assembly in the first embodiment.

FIG. 5A is a cross-sectional view of the cylindrical body coupling part corresponding to VA-VA of FIG. 1A.

FIG. 5B is a cross-sectional view of the cylindrical body coupling part corresponding to VB-VB of FIG. 1A.

FIG. 6 is a cross-sectional view of the cylindrical body coupling part corresponding to VI-VI of FIG. 5A.

FIG. 7A is a perspective view of a first restriction part at the time of routing in the first embodiment.

FIG. 7B is a perspective view of the first restriction part at the time of vehicle assembly in the first embodiment.

FIG. 8 is a perspective view of an inner cylindrical part including a projection making up the first restriction part.

FIG. 9 is a perspective view of an outer cylindrical part including a restriction groove making up the first restriction part.

FIG. 10A is a cross-sectional view of the first restriction part at the time of routing corresponding to XA-XA of FIG. 5A.

FIG. 10B is a cross-sectional view of the first restriction part at the time of vehicle assembly in comparison with FIG. 10A.

FIG. 11A is a cross-sectional view of a second restriction part at the time of routing in a second embodiment.

FIG. 11B is a cross-sectional view of the second restriction part at the time of vehicle assembly in the second embodiment.

FIG. 12A is a cross-sectional view of a cylindrical body coupling part at the time of routing in a third embodiment.

FIG. 12B is a partially enlarged view of the cylindrical body coupling part corresponding to XIIB of FIG. 12A.

FIG. 13 is a perspective view of a bundling band in a fourth embodiment.

FIG. 14A is a cross-sectional view of a third restriction part at the time of routing in the fourth embodiment.

FIG. 14B is a cross-sectional view of the third restriction part at the time of vehicle assembly in the fourth embodiment.

### DETAILED DESCRIPTION OF THE INVENTION

Hereinafter, a protector according to respective embodiments will be described in detail with reference to the drawings. The dimensional ratio of the drawings is exaggerated for the sake of explanation, and may differ from the actual ratio.

### First Embodiment

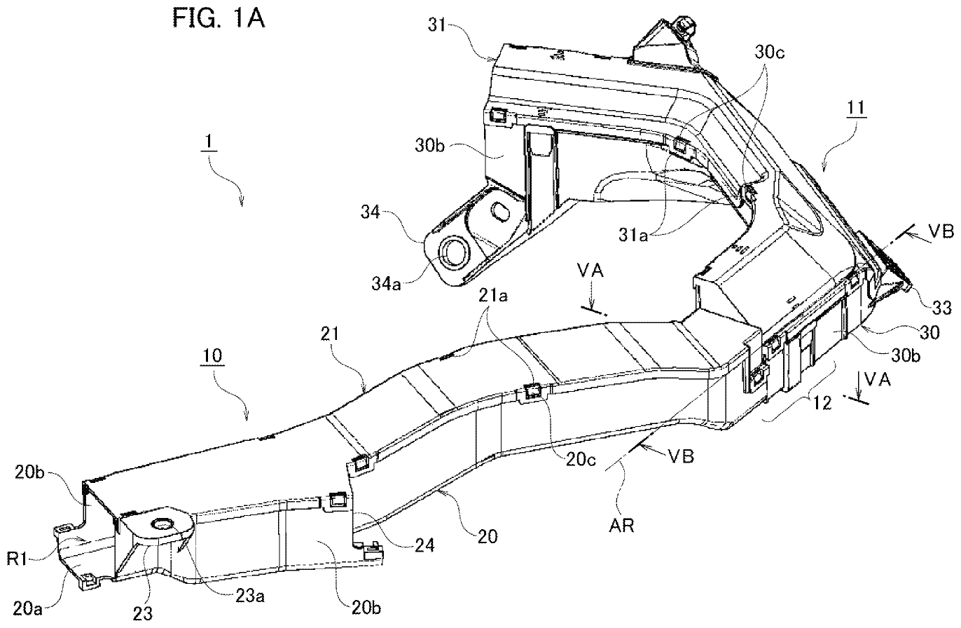

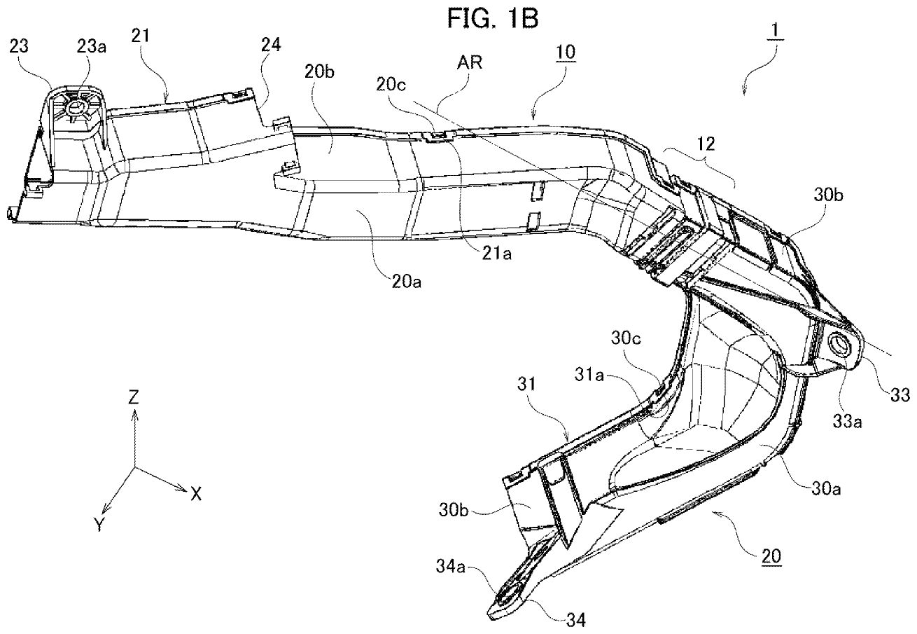

FIG. 1A is a perspective view of a protector 1 according to a first embodiment. FIG. 1B is a perspective view illustrating the rear side of the protector 1 illustrated in FIG. 1A.

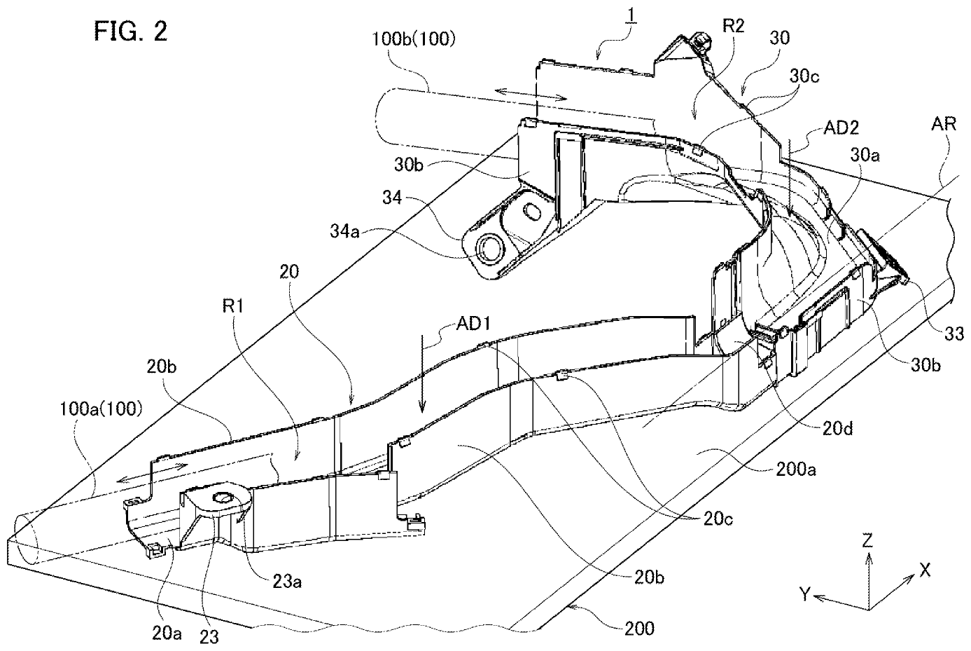

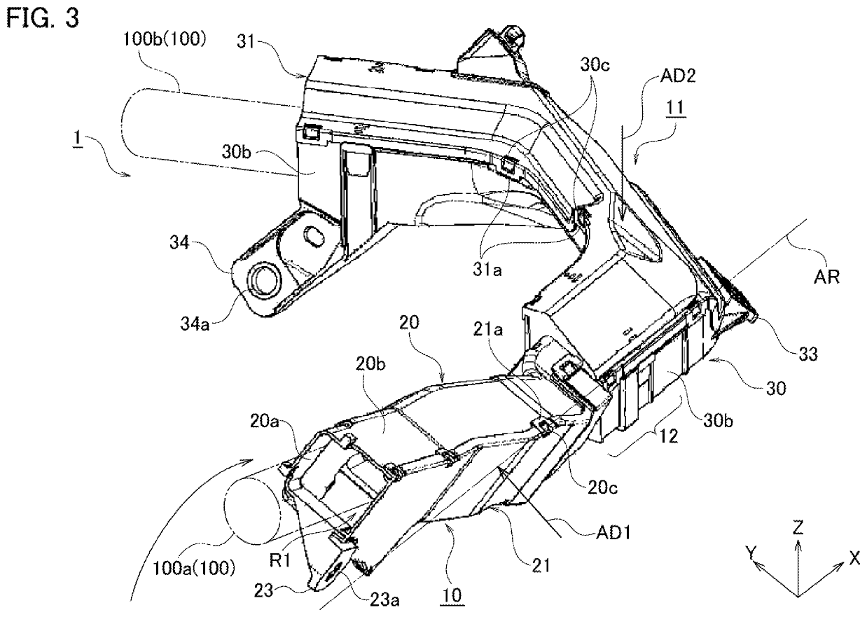

The protector 1 is made of synthetic resin, for example, and protects a wire harness 100 by allowing the wire harness 100 to be penetrated, and is assembled to a predetermined position in the interior of a vehicle such as an automobile (see FIGS. 2 and 3). The protector 1 includes a first cylindrical body 10 and a second cylindrical body 11.

The first cylindrical body 10 includes a first body 20 and a first cover 21.

The first body 20 stores a portion of the wire harness 100 in a first region R1 over the entire extension direction. The overall shape of the first body 20 is long and thin according to the routing path of the wire harness 100 in the interior of the vehicle. In the present embodiment, the extension direction of the first body 20 is not a fixed direction, but a direction in which gentle bending is repeated at several intermediate points on the routing path. The first body 20 has a bottom wall 20a, two side walls 20b having the positional relationship so as to face each other, a plurality of claws 20c, and a vehicle connection part connected to a part of the vehicle.

Each of the two side walls 20b is formed continuously with the side end part of the bottom wall 20a in a posture perpendicular to the bottom wall 20a. Accordingly, in the first body 20, the shape of the transverse plane perpendicular to the extension direction is substantially U-shaped, and a first region R1 is formed in the interior of the first body 20, in which the region facing the bottom wall 20a is opened to the outside.

The plurality of claws 20c are provided separately at appropriate intervals at each end part of the two side walls 20b on the side opposite to the side continuous with the bottom wall 20a. When the first cover 21 is attached to the first body 20, the claws 20c are engaged with engagement holes 21a provided in the first cover 21, thereby allowing the first body 20 to hold the first cover 21.

The vehicle connection part in the first body 20 is a first connection part 23. The first connection part 23 includes, for example, a piece part provided so as to project from one side wall 20b. A first bolt hole 23a is formed in the center portion of the piece part. When a worker attaches the protector 1 to a predetermined position of the vehicle, an attachment bolt (not illustrated) is penetrated into the first bolt hole 23a and fastened to the wall part at the vehicle side. In the first body 20, the specific position of the vehicle connection part or the number thereof to be provided is appropriately set based on the shape required at the vehicle side.

In consideration of the structure of the wire harness 100, the first body 20 may have one or more branch opening parts for exposing branch wires of the wire harness 100 to the outside other than the openings at both end parts in the extension direction of the overall shape. In the present embodiment, a first branch opening part 24 is provided on one side wall 20b.

The first cover 21 is attached to the first body 20 so as to cover the first region R1. As described above, the first cover 21 has a plurality of engagement holes 21a for engaging with the claws 20c provided in the first body 20. Hereinafter, the direction in which the first cover 21 is attached to the first body 20 is defined as a first attachment direction AD1. When the first cover 21 is attached to the first body 20, the first cylindrical body 10 becomes a housing in which the first region R1 is an internal space in which the wire harness 100 is disposed.

The second cylindrical body 11 includes a second body 30 and a second cover 31.

The second body 30 stores at least a portion of the wire harness 100 which is not stored in the first body 20 in a second region R2 which extends over the entire extension direction. The overall shape of the second body 30 is long and thin according to the routing path of the wire harness 100 in the interior of the vehicle. In the present embodiment, the extension direction of the second body 30 is not a fixed direction, but a direction in which large bending is repeated at several intermediate points on the routing path and the whole longitudinal direction is bent in a semi-annular shape. The second body 30 has a bottom wall 30a, two side walls 30b having the positional relationship so as to face each other, a plurality of claws 30c, and a vehicle connection part connected to a part of the vehicle.

Each of the two side walls 30b is formed continuously with the side end part of the bottom wall 30a in a posture perpendicular to the bottom wall 30a. Accordingly, in the second body 30, the shape of the transverse plane perpendicular to the extension direction is substantially U-shaped, and a second region R2 is formed in the interior of the second body 30, in which the region facing the bottom wall 30a is opened to the outside.

The plurality of claws 30c are provided separately at appropriate intervals at each end part of the two side walls 30b on the side opposite to the side continuous with the bottom wall 30a. When the second cover 31 is attached to the second body 30, the claws 30c are engaged with engagement holes 31a provided in the second cover 31, thereby allowing the second body 30 to hold the second cover 31.

The vehicle connection part in the second body 30 is a second connection part 33 and a third connection part 34. Like the first connection part 23, the second connection part 33 and the third connection part 34 also include, for example, a piece part provided so as to project from one side wall 30b. A second bolt hole 33a is formed in the center portion of the piece part constituting the second connection part 33. A third bolt hole 34a is formed in the center portion of the piece part constituting the third connection part 34. When an worker attaches the protector 1 to a predetermined position of the vehicle, an attachment bolt (not illustrated) is penetrated into the second bolt hole 33a and the third bolt hole 34a and fastened to the wall part at the vehicle side. In the second body 30, the specific position of the vehicle connection part or the number thereof to be provided is also appropriately set based on the shape required at the vehicle side.

In consideration of the structure of the wire harness 100, the second body 30 may also have one or more branch opening parts for exposing branch wires of the wire harness 100 to the outside other than the openings at both end parts in the extension direction of the overall shape.

The second cover 31 is attached to the second body 30 so as to cover the second region R2. As described above, the second cover 31 has a plurality of engagement holes 31a for engaging with the claws 30c provided in the second body 30. Hereinafter, the direction in which the second cover 31 is attached to the second body 30 is defined as a second attachment direction AD2. When the second cover 31 is attached to the second body 30, the second cylindrical body 11 becomes a housing in which the second region R2 is an internal space in which the wire harness 100 is disposed.

Further, the protector 1 is deformed at the time of routing and at the time of vehicle assembly by rotating the coupling portion of the first cylindrical body 10 and the second cylindrical body 11.

FIG. 2 is a perspective view of the protector 1 at the time of routing. FIG. 3 is a perspective view of the protector 1 at the time of vehicle assembly. In FIGS. 2 and 3, a portion of the wire harness 100 is schematically illustrated in a cylindrical shape.

“At the time of routing” refers to the working time when an worker routes the wire harness 100 in the protector 1 before vehicle assembly. At the time of routing, the first cover 21 and the second cover 31 are removed from the first body 20 or the second body 30. The first body 20 and the second body 30 are placed on an adjustment surface 200a in a flat-shaped jig 200 in a state in which they are coupled at a portion of a cylindrical body coupling part 12 which will be described later. At this time, the first attachment direction AD1 in the first body 20 and the second attachment direction AD2 in the second body 30 are in the same direction as illustrated in FIG. 2.

Meanwhile, “at the time of vehicle assembly” refers to the working time when an worker assembles the protector 1 in which the wire harness 100 is routed to the vehicle. At the time of vehicle assembly, the first cylindrical body 10 rotates with respect to the second cylindrical body 11 around a rotation axis AR as a center axis. At this time, the first cylindrical body 10 and the second cylindrical body 11 differ greatly in three dimensions in the extension direction of the routing path to be laid, and the overall shape of the protector 1 becomes a so-called three-dimensional shape. Accordingly, the first attachment direction AD1 and the second attachment direction AD2 are not in the same direction as illustrated in FIG. 3.

Here, for the sake of the following explanation, each direction is defined as follows. The Z direction is along the vertical direction. The X and Y directions are perpendicular to each other on a horizontal plane perpendicular to the Z direction. In particular, the X direction is parallel to the rotation axis AR.

Further, the protector 1 includes the cylindrical body coupling part 12 as the coupling portion of the first cylindrical body 10 and the second cylindrical body 11.

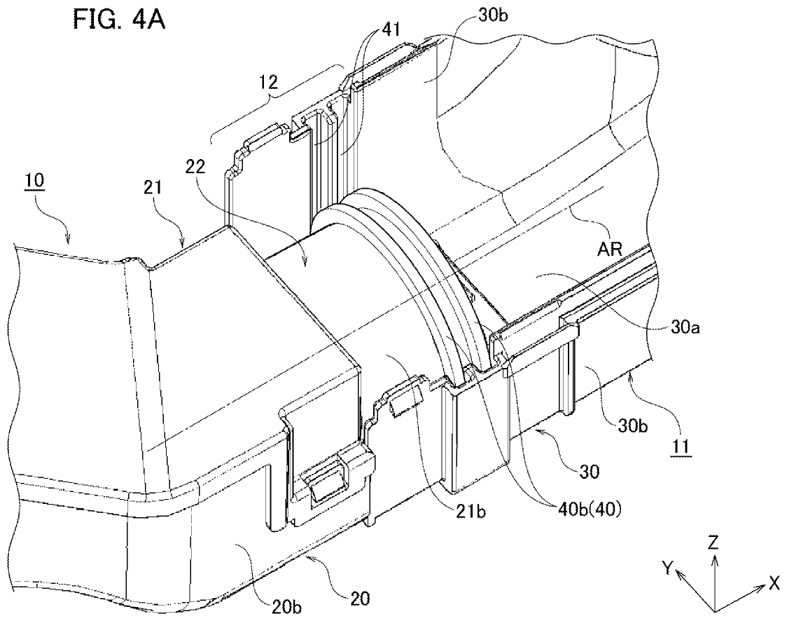

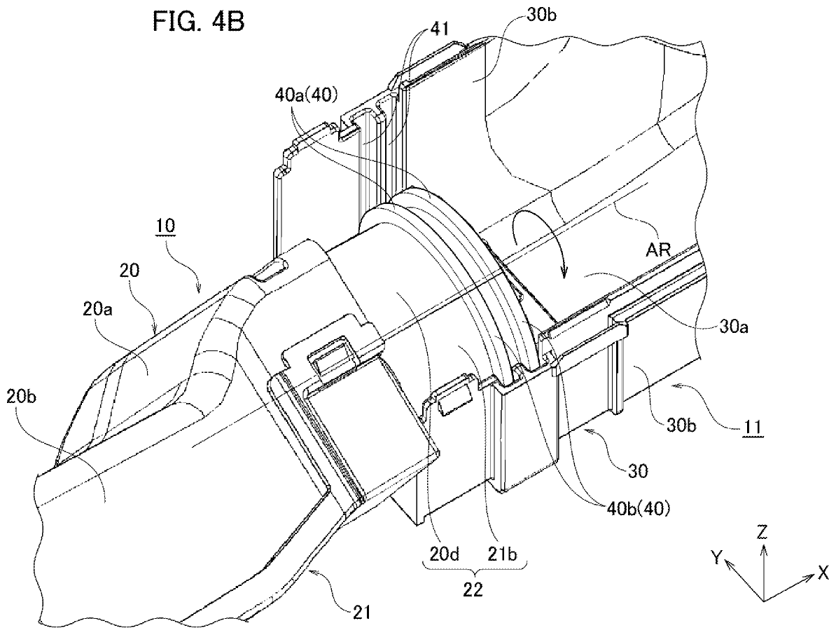

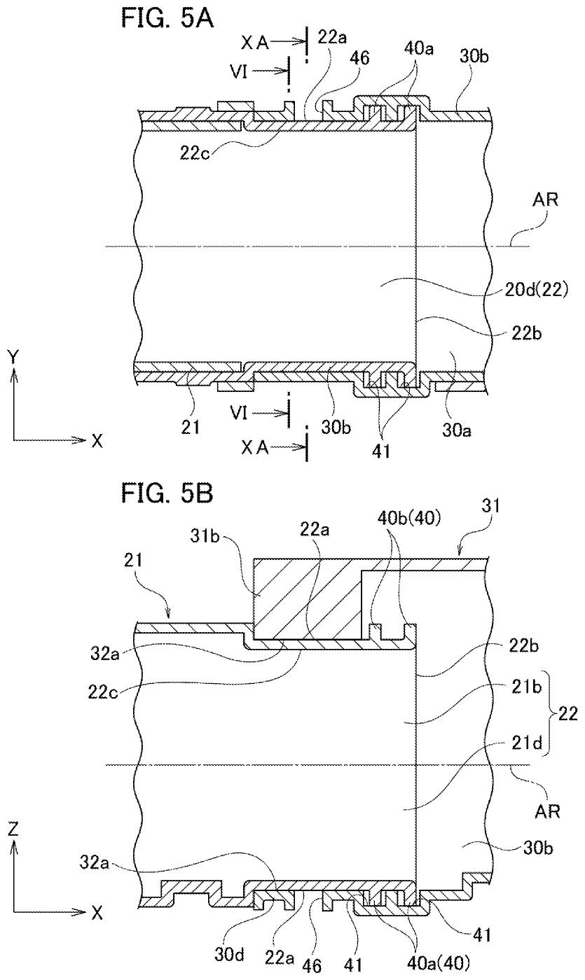

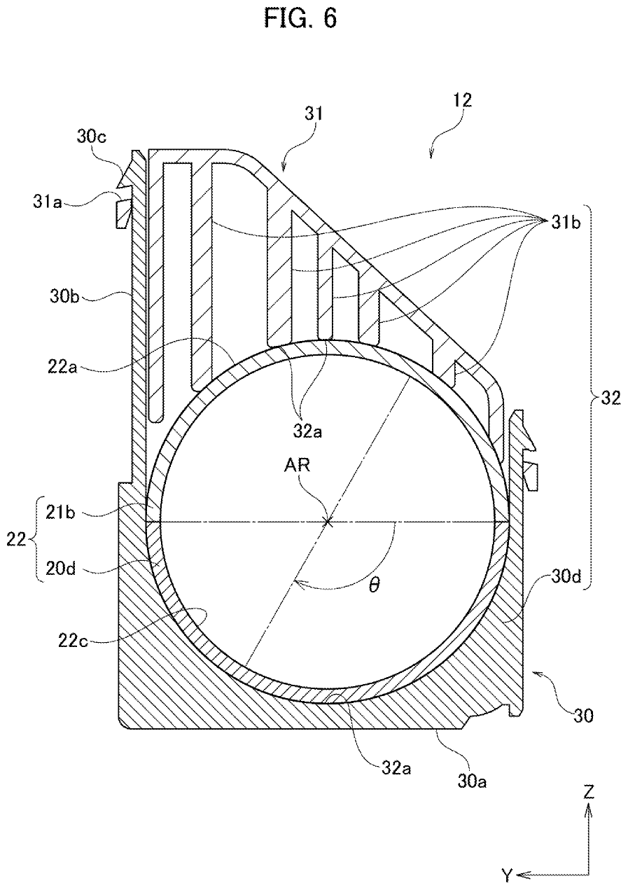

FIG. 4A is a perspective view illustrating the cylindrical body coupling part 12 when the protector 1 is in a posture at the time of routing. FIG. 4B is a perspective view illustrating the cylindrical body coupling part 12 when the protector 1 is in a posture at the time of vehicle assembly. FIGS. 4A and 4B illustrate a state in which the second cover 31 is removed from the second body 30 in order to visually recognize the interior of the cylindrical body coupling part 12. FIG. 5A is a cross-sectional view of the cylindrical body coupling part 12, which corresponds to VA-VA of FIG. 1A and is cut in the XY plane passing through the rotation axis AR. FIG. 5B is a cross-sectional view of the cylindrical body coupling part 12, which corresponds to VB-VB of FIG. 1A and is cut in the XZ plane passing through the rotation axis AR. FIG. 6 is a cross-sectional view of the cylindrical body coupling part 12, which corresponds to VI-VI of FIG. 5A and is cut in the YZ plane at the position not including a restriction groove 46 which will be described later.

The cylindrical body coupling part 12 is a combination of an inner cylindrical part 22 which is a part of the first cylindrical body 10 and an outer cylindrical part 32 (see FIG. 6) which is a part of the second cylindrical body 11. The inner cylindrical part 22 is a cylindrical part provided at one end of the first cylindrical body 10 in the extension direction. The outer cylindrical part 32 is provided at one end of the second cylindrical body 11 in the extension direction, and rotates the inner cylindrical part 22 around the rotation axis AR while holding the inner cylindrical part 22 at the inner side thereof. That is, the cylindrical body coupling part 12 is also a rotation mechanism for rotating the first cylindrical body 10 with respect to the second cylindrical body 11.

The inner cylindrical part 22 is a combination of a first semi-cylindrical part 20d formed in the first body 20 and a second semi-cylindrical part 21b formed in the first cover 21. Since the inner cylindrical part 22 has a cylindrical shape, the shape of the transverse plane of an outer peripheral part 22a of the inner cylindrical part 22 is a perfect circle. The region surrounded by an inner peripheral part 22c of the inner cylindrical part 22 allows the wire harness 100 to penetrate as a portion of the first region R1.

The outer cylindrical part 32 is a combination of a first support part 30d formed in the second body 30 and second support parts 31b formed in the second cover 31. As illustrated in FIG. 6, inner peripheral parts 32a of the outer cylindrical part 32 include an perfect-circular inner wall formed continuously along the YZ plane in the first support part 30d, and tip-end parts in the second support parts 31b which are formed intermittently along the YZ plane. The inner surface shape of the inner wall in the first support part 30d is roughly identical with the outer surface shape of the outer peripheral part 22a of the inner cylindrical part 22. The second support parts 31b are formed, for example, by a combination of several reinforcing walls whose intersection lines are along the Z direction. In this case, the tip-end parts of the second support parts 31b constituting the inner peripheral parts 32a are also the tip-end parts of the reinforcing walls. The outer cylindrical part 32 rotatably holds the inner cylindrical part 22 by bringing the outer peripheral part 22a of the inner cylindrical part 22 whose shape of the transverse plane is a perfect circle into contact with the inner peripheral parts 32a.

Here, the rotation angle θ of the inner cylindrical part 22 changes between the first angle θ1 and the second angle θ2. The first angle θ1 is the angle when the first attachment direction AD1 is in the same direction as the second attachment direction AD2 and the protector 1 is in a posture at the time of routing. In the present embodiment, since the first angle θ1 is the angle when the first attachment direction AD1 is in the same direction as the second attachment direction AD2. Accordingly, the first angle θ1 can be regarded as the angle when the inner cylindrical part 22 does not rotate, and thus it is approximately 0°. The second angle θ2 is the angle when the first attachment direction AD1 is not in the same direction as the second attachment direction AD2 and when the protector 1, that is, the first cylindrical body 10 and the second cylindrical body 11 are in the respective postures at the time of vehicle assembly.

In the cylindrical body coupling part 12, the outer peripheral part 22a of the inner cylindrical part 22 has a rib 40 extending in the circumferential direction and projecting toward the inner peripheral part 32a of the outer cylindrical part 32. Meanwhile, the inner peripheral part 32a of the outer cylindrical part 32 has an engagement groove 41 engaged with the rib 40 in the rotational direction of the inner cylindrical part 22.

The rib 40 is a combination of a first semi-ring part 40a provided in the first semi-cylindrical part 20d and a second semi-ring part 40b provided in the second semi-cylindrical part 21b, and as a whole, the rib 40 has an annular shape with the rotation axis AR as an approximate center axis. In the present embodiment, two ribs 40 have the same shape, and are provided spaced apart from each other in the extension direction of the inner cylindrical part 22. These ribs 40 are provided at the tip-end parts 22b of the inner cylindrical part 22 in the extension direction.

In the present embodiment, the engagement groove 41 is formed over the entire circumference of the first support part 30d of the outer cylindrical part 32, and guides the ribs 40 such that the inner cylindrical part 22 rotates around the rotation axis AR. Further, in the present embodiment, two engagement grooves 41 have the same shape, and are provided spaced apart from each other in the extension direction of the outer cylindrical part 32, and two engagement grooves 41 are provided according to two ribs 40 described above.

Further, the cylindrical body coupling part 12 has a first restriction part 13 that restricts the rotation angle θ of the inner cylindrical part 22 in the range of the first angle θ1 and the second angle θ2.

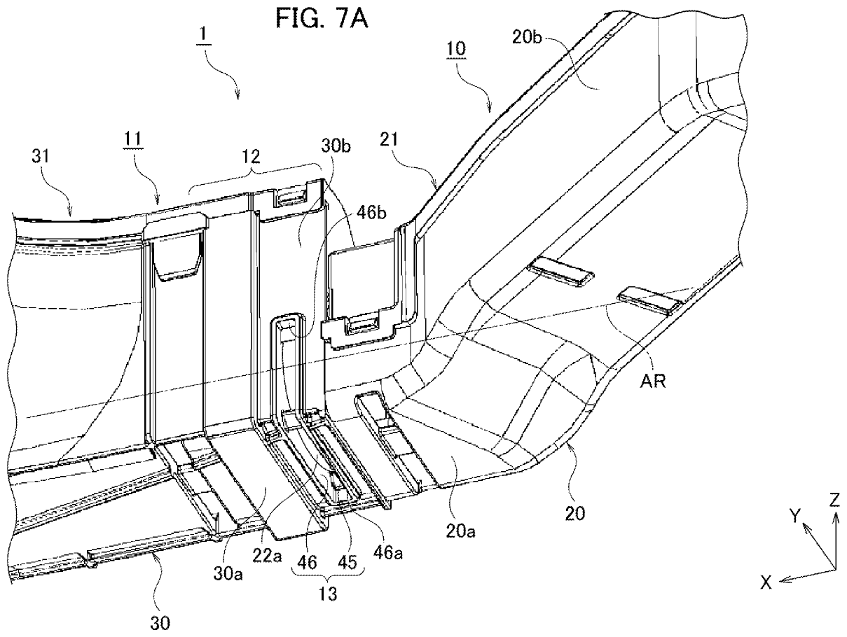

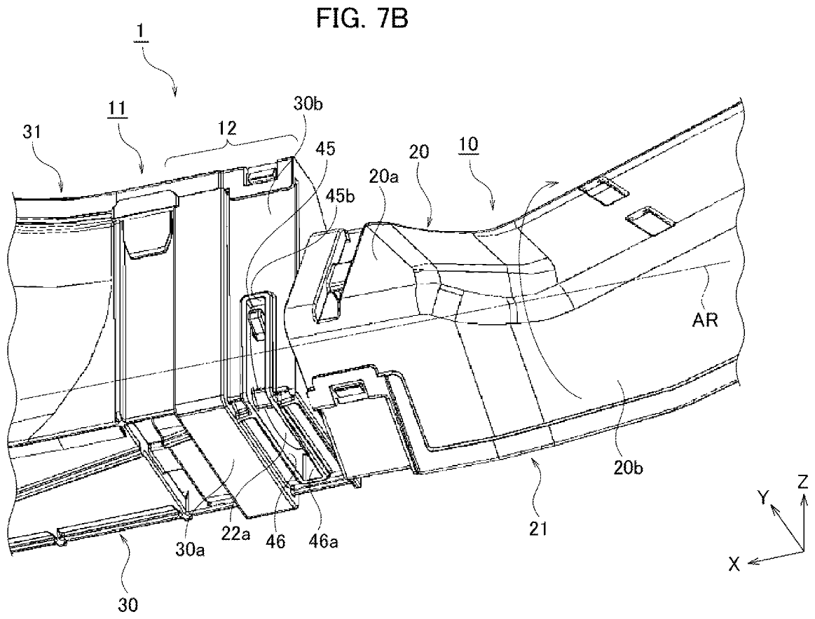

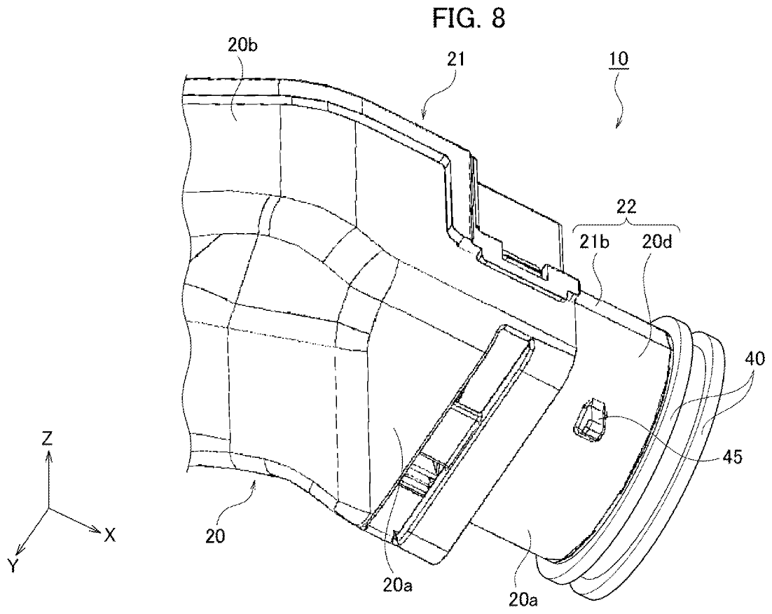

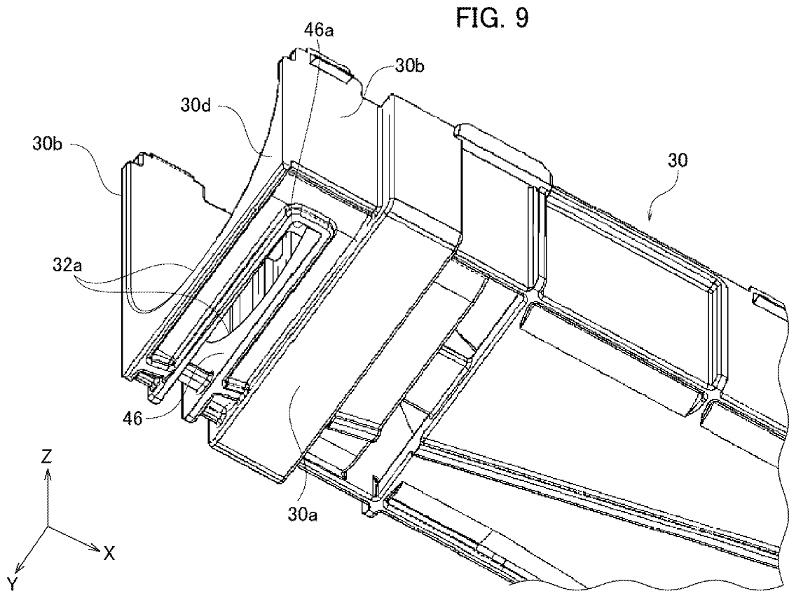

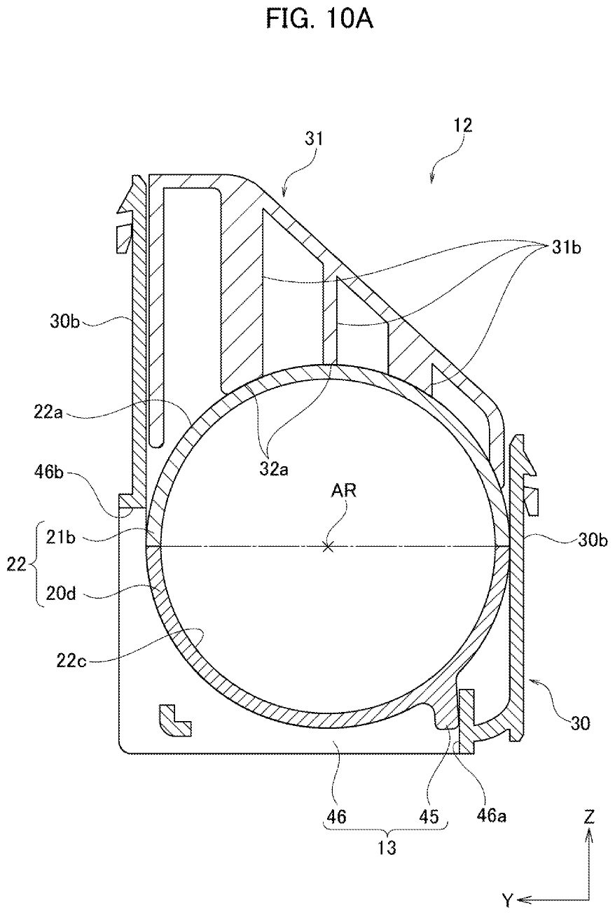

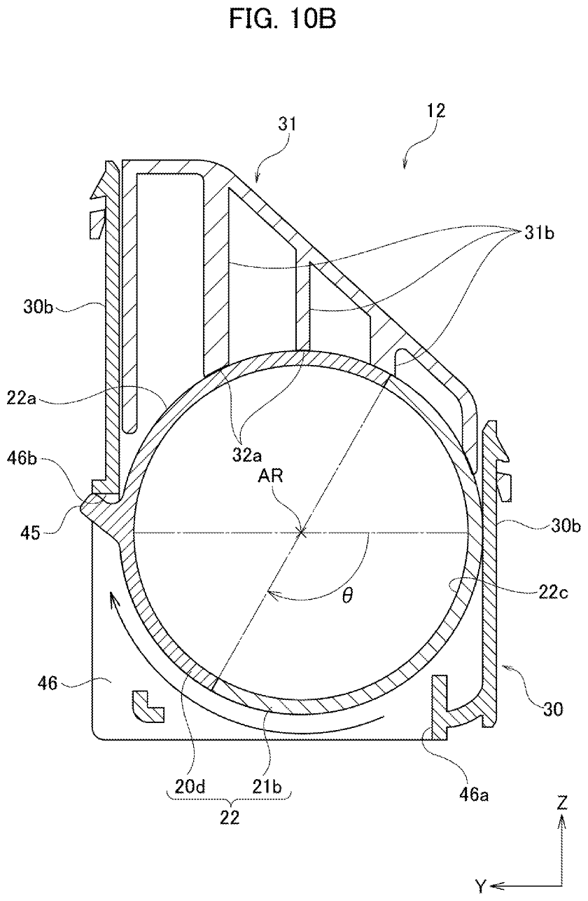

FIG. 7A is a perspective view of the first restriction part 13 at the time of routing. FIG. 7B is a perspective view of the first restriction part 13 at the time of vehicle assembly. FIG. 8 is a perspective view of the inner cylindrical part 22 including a projection 45. FIG. 9 is a perspective view of the outer cylindrical part 32 including the restriction groove 46. FIG. 10A is a cross-sectional view of the first restriction part 13 at the time of routing, which corresponds to XA-XA of FIG. 5A and is cut in the YZ plane in the position including the restriction groove 46. FIG. 10B is a cross-sectional view of the first restriction part 13 at the time of vehicle assembly, which is compared with FIG. 10A.

The first restriction part 13 includes the projection 45 and the restriction groove 46.

The projection 45 is provided on the outer peripheral part 22a of the inner cylindrical part 22 so as to project toward the inner peripheral part 32a of the outer cylindrical part 32.

The restriction groove 46 is provided on the bottom wall 30a and the side walls 30b including the inner peripheral parts 32a of the outer cylindrical part 32 partially so as to store a portion of the projection 45 and restrict the movement of the projection 45 in a certain range in the circumferential direction. In the present embodiment, the restriction groove 46 penetrates the inside and outside of the second body 30. In the restriction groove 46, a first end part 46a, which is one end part in the direction along the movement direction of the projection 45, is in the position where the projection 45 comes into contact with the first end part 46a when the rotation angle θ of the inner cylindrical part 22 is the first angle θ1, as illustrated in FIG. 10A. Meanwhile, in the restriction groove 46, a second end part 46b, which is the other end part in the direction along the movement direction of the projection 45, is in the position where the projection 45 comes into contact with the second end part 46b when the rotation angle θ of the inner cylindrical part 22 is the second angle θ2, as illustrated in FIG. 10B.

Next, a description will be given regarding a flow until the protector 1 is assembled to the vehicle.

Before the protector 1 is assembled to the vehicle, a worker performs the work for disposing the wire harness 100 in the protector 1. Referring to FIG. 2, the worker first places the protector 1 on the adjustment surface 200a of the jig 200 such that the first attachment direction AD1 and the second attachment direction AD2 are in the same direction, that is, the rotation angle θ of the inner cylindrical part 22 becomes the first angle θ1. In the present embodiment, both the first attachment direction AD1 and the second attachment direction AD2 are along the Z direction. Next, the worker removes the first cover 21 and the second cover 31 from the first body 20 or the second body 30. At this time, in the protector 1, the direction in which the entire first region R1 of the first body 20 is opened to the outside and the direction in which the entire second region R2 of the second body 30 is opened to the outside are both along the Z direction. Accordingly, the first body 20 and the second body 30 are stably held on the adjusting surface 200a which is a horizontal plane, and the direction in which the first region R1 of the first body 20 is opened and the direction in which the second region R2 of the second body 30 is opened are in the same direction. The overall shape of the protector 1 when the first body 20 and the second body 30 are held in this way can be called a 2D shape, which means a planar shape, and a three-dimensional shape can be called a 3D shape.

The worker then disposes the wire harness 100 in the first region R1 or the second region R2 along the first attachment direction AD1 and the second attachment direction AD2. Thereafter, as illustrated in FIG. 2, the worker performs dimensioning a first wiring part 100a of the wire harness 100 to be disposed in the first region R1. Subsequently, the worker performs dimensioning a second wiring part 100b of the wire harness 100 to be disposed in the second region R2 without changing the posture of the protector 1. Lastly, the worker completes the routing work by attaching the first cover 21 to the first body 20 and attaching the second cover 31 to the second body 30.

Next, the worker performs the work for assembling the protector 1 in which the wire harness 100 is routed, to a predetermined position in the vehicle. Referring to FIG. 3, the worker first rotates the first cylindrical body 10 around the rotation axis AR with respect to the protector 1 in the planar shape that is at the time of routing while maintaining the posture of the second cylindrical body 11, and deforms the protector 1 to a three-dimensional shape that is at the time of vehicle assembly. In the present embodiment, in the cylindrical body coupling part 12, the rotation angle θ of the inner cylindrical part 22 is specified in the range of the first angle θ1 and the second angle θ2 by the first restriction part 13. Accordingly, the worker can deform the protector 1 to a desired three-dimensional shape by simply rotating the first cylindrical body 10 until the projection 45 comes into contact with the second end part 46b.

The worker then places the three-dimensional protector 1 at the predetermined position of the vehicle, and connects the first connection part 23, the second connection part 33, and the third connection part 34 to the fixed parts in the vehicle, respectively, thereby completing the vehicle assembly work.

Next, the effect of the protector 1 will be described.

A protector 1 is assembled to a vehicle in a state in which a wire harness 100 is penetrated. The protector 1 includes a first cylindrical body 10 having a first body 20 which stores a portion of the wire harness 100 in a first region R1 over an entire extension direction and a first cover 21 which is attached to the first body 20 in a first attachment direction AD1 so as to cover the first region R1. The protector 1 also includes a second cylindrical body 11 having a second body 30 which stores a portion of the wire harness 100 in a second region R2 over an entire extension direction and a second cover 31 which is attached to the second body 30 in a second attachment direction AD2 so as to cover the second region R2. A portion of the wire harness 100 stored in the second region R2 is at least a portion not stored in the first body 20. One end of the first cylindrical body 10 in the extension direction is an inner cylindrical part 22 formed into a cylindrical shape. One end of the second cylindrical body 11 in the extension direction is an outer cylindrical part 32 which rotates the inner cylindrical part 22 around an axis while holding the inner cylindrical part 22 at an inner side thereof. A rotation angle θ of the inner cylindrical part 22 changes between a first angle θ1 in which the first attachment direction AD1 is in a same position as the second attachment direction AD2 and a second angle θ2 in which the first attachment direction AD1 is not in a same position as the second attachment direction AD2 and which is in a posture when the first cylindrical part 10 and the second cylindrical part 11 are assembled to the vehicle.

For example, it is assumed that the overall shape of the protector 1 when it is assembled to the vehicle has a three-dimensional shape in which the extension directions of each part differ complicatedly in three dimensions as described above. In the protector 1 having a three-dimensional shape, the first attachment direction AD1 and the second attachment direction AD2 differ greatly.

In this case, in the protector 1, when the wire harness 100 is routed in the first region R1 and the second region R2, the protector 1 is deformed to a posture in which the first attachment direction AD1 is in the same position as the second attachment direction AD2, that is, to a posture in which the rotation angle θ of the inner cylindrical part 22 becomes the first angle θ1. At this time, the protector 1 is stably held on the adjustment surface 200a of the jig 200 in such a planar posture. For this reason, the worker can perform dimensioning of each part of the wire harness 100 to both the first region R1 and the second region R2 at one time without changing the posture of the protector 1. Thereafter, when assembling the protector 1 to the vehicle, the worker can form the protector 1 into a desired three-dimensional shape by simply rotating the first cylindrical body 10 and deforming the protector 1 to the posture such that the rotation angle θ of the inner cylindrical part 22 becomes the second angle θ2.

Here, as a comparative example, it is assumed that a protector having a three-dimensional shape equivalent to the three-dimensional shape of the protector 1 according to the present embodiment at the time of vehicle assembly is conventionally present, and the conventional protector does not have a rotation mechanism unlike the protector 1. In this case, the overall shape of the conventional protector is constant in a three-dimensional shape, in which the attachment direction of the cover differs greatly for each cylindrical body as illustrated in FIG. 3. For this reason, at the time of routing, the worker first sets the first attachment direction to be along the Z direction by having the first jig support the portion corresponding to the first cylindrical body 10, and performs a first step of routing work. Next, the worker sets the second attachment direction to be along the Z direction by having the second jig support the portion corresponding to the second cylindrical body 11 that is connected to the first cylindrical body 10, and performs a second step of routing work. That is, at the time of routing in this comparative example, the cylindrical body is supported again by the second jig, thereby complicating the routing work.

In contrast to this comparative example, according to the protector 1 of the present embodiment, the routing work is simplified because no process in which the cylindrical body is supported again by the second jig is required at the time of routing.

As described above, according to the present embodiment, it is possible to provide the protector 1 which improves the routing workability of the wire harness 100 when the protector 1 becomes a three-dimensional shape at the time of vehicle assembly. In addition, in the comparative example described above, a plurality of jigs are required because the cylindrical body is supported again at the time of routing. In contrast, the number of jigs required at the time of routing can be reduced according to the protector 1, and thus the manufacturing cost can be reduced, for example.

In the protector 1, one of the outer peripheral part 22a of the inner cylindrical part 22 or the inner peripheral part 32a of the outer cylindrical part 32 may have a rib extending in the circumferential direction and projecting toward the other thereof. The other of the outer peripheral part 22a of the inner cylindrical part 22 or the inner peripheral part 32a of the outer cylindrical part 32 may have an engagement groove engaged with the rib in the rotational direction of the inner cylindrical part 22. The rib or the engagement groove of the inner cylindrical part 22 may be provided at the tip-end part 22b of the inner cylindrical part 22 in the extension direction.

In the examples with reference to the above figures, the outer peripheral part 22a of the inner cylindrical part 22 has the rib 40, and the inner peripheral part 32a of the outer cylindrical part 32 has the engagement groove 41.

According to the protector 1, since the rib 40 and the engagement groove 41 are rotatably engaged with each other, the first cylindrical part 10 can be smoothly rotated with respect to the second cylindrical part 11, and it is possible to suppress deviation, inclination, or unintentional deformation between the first cylindrical part 10 and the second cylindrical part 11. Further, according to the protector 1, since the rib 40 is provided at the tip-end part 22b of the inner cylindrical part 22, it is advantageous in that the rib 40 is easily positioned with respect to the engagement groove 41 when the first cylindrical part 10 and the second cylindrical part 11 are coupled, for example.

Unlike the examples with reference to the above figures, the same effect is achieved even if the outer peripheral part 22a of the inner cylindrical part 22 has an engagement groove and the inner peripheral part 32a of the outer cylindrical part 32 has a rib. In this case, an engagement groove is provided at the tip-end part 22b of the inner cylindrical part 22 in the extension direction in place of the rib 40 in the above example.

In the protector 1, one of the outer peripheral part 22a of the inner cylindrical part 22 or the inner peripheral part 32a of the outer cylindrical part 32 may have a projection projecting toward the other thereof. The other of the outer peripheral part 22a of the inner cylindrical part 22 or the inner peripheral part 32a of the outer cylindrical part 32 may have a restriction groove which stores a portion of the projection and restricts a movement of the projection in a certain range in the circumferential direction. The first end part, which is one end part of the restriction groove, may be in the position where the projection comes into contact with the first end part when the rotation angle θ of the inner cylindrical part 22 is the first angle θ1. The second end part, which is the other end part of the restriction groove, may be in the position where the projection comes into contact with the second end part when the rotation angle θ of the inner cylindrical part 22 is the second angle θ2.

In the examples with reference to the above figures, the outer peripheral part 22a of the inner cylindrical part 22 has the projection 45, and the inner peripheral part 32a of the outer cylindrical part 32 has the restriction groove 46. Further, one end part of the restriction groove 46 is the first end part 46a, and the other end part of the restriction groove 46 is the second end part 46b.

According to the protector 1, the rotation angle θ of the inner cylindrical part 22 is restricted to a range of a first angle θ1 at which the projection 45 comes into contact with the first end part 46a, and a second angle θ2 at which the projection 45 comes into contact with the second end part 46b. For this reason, a worker can easily deform the overall shape of the protector 1 to either a planar shape at the time of routing or a three-dimensional shape at the time of vehicle assembly by simply rotating the first cylindrical part 10 until the projection 45 comes into contact with either the first end part 46a or the second end part 46b. Further, since the range of the rotation angle θ of the inner cylindrical part 22 is restricted, it is possible to prevent a state in advance, such as excessive rotation of the first cylindrical part 10 with respect to the second cylindrical part 11, and excessive twisting of the wire harness 100 at the interior of the protector 1.

Unlike the examples with reference to the above figures, the same effect is achieved even if the outer peripheral part 22a of the inner cylindrical part 22 has a restriction groove and the inner peripheral part 32a of the outer cylindrical part 32 has a projection.

### Second Embodiment

In the first embodiment, the first restriction part 13 configured of the projection 45 and the restriction groove 46 has been exemplified as a restriction part which restricts the rotation angle θ of the inner cylindrical part 22 in the range of the first angle θ1 and the second angle θ2. Meanwhile, in the second embodiment, a case will be described as an example in which the protector 1 includes a second restriction part 51 in place of the first restriction part 13.

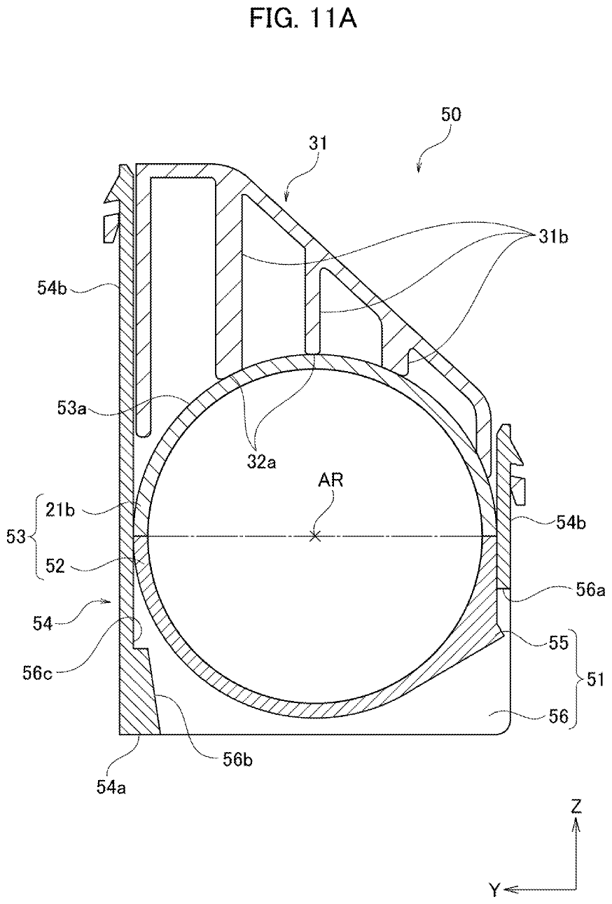

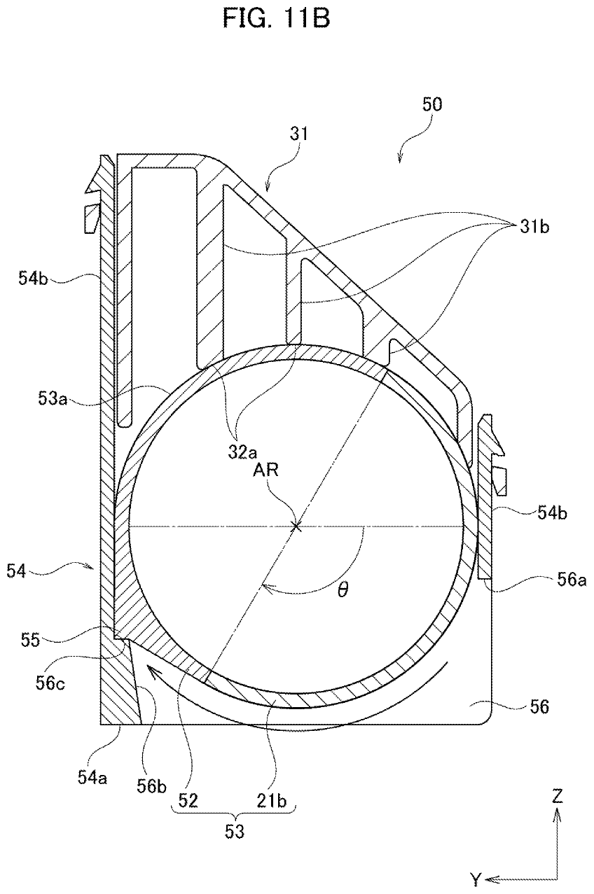

FIG. 11A is a cross-sectional view of the second restriction part 51 at the time of routing. FIG. 11B is a cross-sectional view of the second restriction part 51 at the time of vehicle assembly. As in FIGS. 10A and 10B of the first embodiment, FIGS. 11A and 11B are diagrams which correspond to XA-XA of FIG. 5A and are cut in the YZ plane at the position including a restriction groove 56 which will be described later.

The protector 1 according to the present embodiment includes a cylindrical body coupling part 50 in place of the cylindrical body coupling part 12 of the first embodiment. The cylindrical body coupling part 50 has the second restriction part 51 including a projection 55 and a restriction groove 56.

The cylindrical body coupling part 50 has an inner cylindrical part 53 in place of the inner cylindrical part 22 of the first embodiment. The shape of the transverse plane of the outer peripheral part 53a of the inner cylindrical part 53 is also a perfect circle. The inner cylindrical part 53 has the second semi-cylindrical part 21b formed on the first cover 21 in the same manner as the inner cylindrical part 22, but differs from the inner cylindrical part 22 in that the first semi-cylindrical part 52 formed on the first body 20 has a projection 55 in place of the projection 45 of the first embodiment. The tip-end part of the projection 55 is formed relatively sharply.

The cylindrical body coupling part 50 forms a portion of the outer cylindrical part in the second body 54 in place of the second body 30 of the first embodiment. In this case, a portion of the outer cylindrical part is set to a portion of the bottom wall 54a and two side walls 54b constituting the second body 54, and in the present embodiment, a portion of the outer cylindrical part has the restriction groove 56 in place of the restriction groove 46 of the first embodiment.

The restriction groove 56 stores a portion of the projection 55 to restrict the movement of the projection 55 in a certain range in the circumferential direction. In the present embodiment, the restriction groove 56 also penetrates the inside and outside of the second body 54. In the restriction groove 56, a first end part 56a, which is one end part in the direction along the movement direction of the projection 55, is in the position where the projection 55 comes into contact with the first end part 56a when the rotation angle θ of the inner cylindrical part 53 is the first angle θ1, as illustrated in FIG. 11A. Meanwhile, in the restriction groove 56, a second end part 56b, which is the other end part in the direction along the movement direction of the projection 55, is in the position where the projection 55 comes into contact with the second end part 56b when the rotation angle θ of the inner cylindrical part 53 is the second angle θ2, as illustrated in FIG. 11B.

Here, in the present embodiment, in the restriction groove 56, the second end part 56b has a projection receiving portion 56c in which a portion of the projection 55 is fitted when the projection 55 comes into contact with the second end part 56b. The projection receiving portion 56c is, for example, a notch part in which a portion of the tip-end part of the projection 55 is fitted according to the shape of the tip-end part thereof. The projection receiving portion 56c has at least a shape with which it is possible to restrain the projection 55 from returning to the first end part 56a side after a portion of the projection 55 is fitted therein.

Thus, in the protector 1 according to the present embodiment, the second end part 56b may have the projection receiving portion 56c in which a portion of the projection 55 is fitted when the projection 55 comes into contact with the second end part 56b.

According to the present embodiment, since the projection 55 is kept in contact with the second end part 56b by being fitted in the projection receiving portion 56c, the first cylindrical body 10 is in a so-called locked state, in which it cannot be rotated only by receiving a small external force. Accordingly, after the worker has finished the routing of the wire harness 100 with respect to the protector 1 and the protector 1 is deformed into a three-dimensional shape by rotating the first cylindrical body 10, the protector 1 can be maintained in the three-dimensional shape. Thus, for example, when the routing work and the vehicle assembly work are carried out in different places, the worker can have the protector 1 in which the routing work is finished delivered in a state of a three-dimensional shape to the place where the vehicle assembly work is carried out. According to such a delivery method, it is not necessary to carry out the work, such as adjusting the rotation position of the protector 1, at the place where the vehicle assembly work is carried out.

### Third Embodiment

In the first embodiment, a case has been described as an example in which the first semi-cylindrical part 20d and the second semi-cylindrical part 21b constituting the inner cylindrical part 22 are brought into contact with each other at the side end parts in the circumferential direction, and the contact surfaces at the respective side end parts are formed into a simple plan shape. Meanwhile, in the third embodiment, a case will be described as an example in which the protector 1 includes an inner cylindrical part 61 in place of the inner cylindrical part 22.

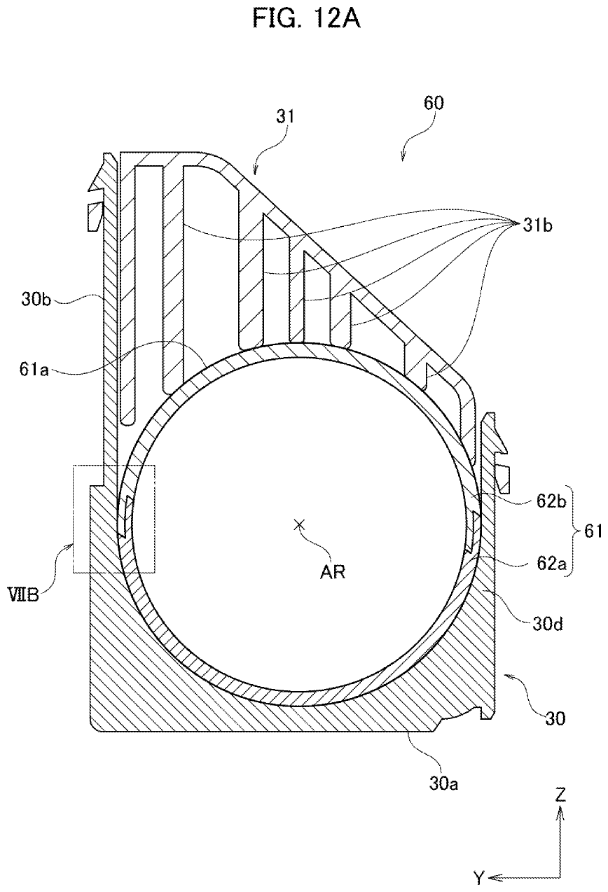

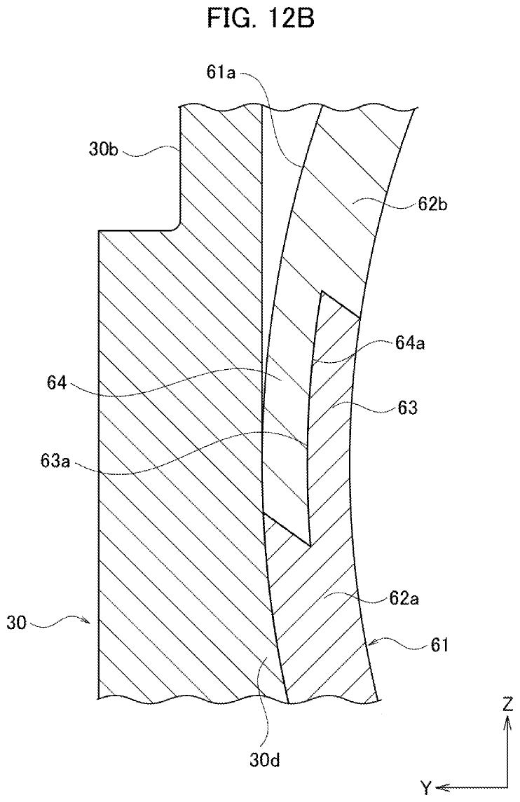

FIG. 12A is a cross-sectional view of a cylindrical body coupling part 60 at the time of routing in the third embodiment. As in FIG. 6 of the first embodiment, FIG. 12A is a diagram which corresponds to VI-VI of FIG. 5A and is cut in the YZ plane at the position not including the restriction groove 46. FIG. 12B is a partially enlarged view of the cylindrical body coupling part 60 corresponding to XIIB of FIG. 12A.

The protector 1 according to the present embodiment includes a cylindrical body coupling part 60 in place of the cylindrical body coupling part 12 of the first embodiment. The inner cylindrical part 61 in the cylindrical body coupling part 60 is a combination of a first semi-cylindrical part 62a which is a part of the first body 20 and a second semi-cylindrical part 62b which is a part of the first cover 21. The structure of the cylindrical body coupling part 60 other than the inner cylindrical part 61 is the same as the corresponding structure of the cylindrical body coupling part 12.

The inner cylindrical part 61 is formed into a cylindrical shape as a whole because a first side end part 63 of the first semi-cylindrical part 62a and a second side end part 64 of the second semi-cylindrical part 62b come into contact with each other at two places in the circumferential direction. Here, the first side end part 63 has a notch part 63a on the inner circumferential side or the outer circumferential side along the direction of the rotation axis AR of the inner cylindrical part 61 such that a portion thereof enters the interior of the cylindrical wall along the circumferential direction. Similarly, the second side end part 64 has a notch part 64a on the inner circumferential side or the outer circumferential side along the direction of the rotation axis AR of the inner cylindrical part 61 such that a portion thereof enters the interior of the cylindrical wall along the circumferential direction. At this time, the first side end part 63, and the second side end part 64 which is in contact with the first side end part 63 have a shape symmetrical to each other in the circumferential direction. A portion of the second side end part 64 is engaged with the notch part 63a, and a portion of the first side end part 63 is engaged with the notch part 64a, thereby forming the inner cylindrical part 61.

Thus, in the protector 1 according to the present embodiment, the inner cylindrical part 61 may be a combination of the first semi-cylindrical part 62a which is a part of the first body 20 and the second semi-cylindrical part 62b which is a part of the first cover 21. The first side end part 63 of the first semi-cylindrical part 62a may have a notch part 63a on the inner circumferential side or the outer circumferential side along the axial direction of the inner cylindrical part 61 such that a portion thereof may enter the interior of the cylindrical wall along the circumferential direction. The second side end part 64 of the second semi-cylindrical part 62b may have a shape symmetrical to the first side end part 63 in the circumferential direction. A portion of the second side end part 64 may be engaged with the notch part 63a of the first side end part 63, and a portion of the first side end part 63 may be engaged with the notch part 64a of the second side end part 64.

According to the present embodiment, in the inner cylindrical part 61, the first side end part 63 and the second side end part 64 do not simply come into contact with each other at the contact surfaces formed into a plan shape, but come into contact with each other in a mutually engaging manner. Accordingly, the inner cylindrical part 61 can suppress deviation, inclination, or unintentional deformation between the first semicircular cylindrical part 62a and the second semicircular cylindrical part 62b, and can maintain the true circular shape of the outer peripheral part 61a of the inner cylindrical part 61, and thus the inner cylindrical part 61 can rotate smoothly on a steady basis.

### Fourth Embodiment

In the first embodiment, the first restriction part 13 including the projection 45 formed in the inner cylindrical part 22 has been exemplified as a restriction part which restricts the rotation angle θ of the inner cylindrical part 22 in the range of the first angle θ1 and the second angle θ2. Meanwhile, in the fourth embodiment, a case will be described as an example in which the protector 1 includes a third restriction part 71 in place of the first restriction part 13.

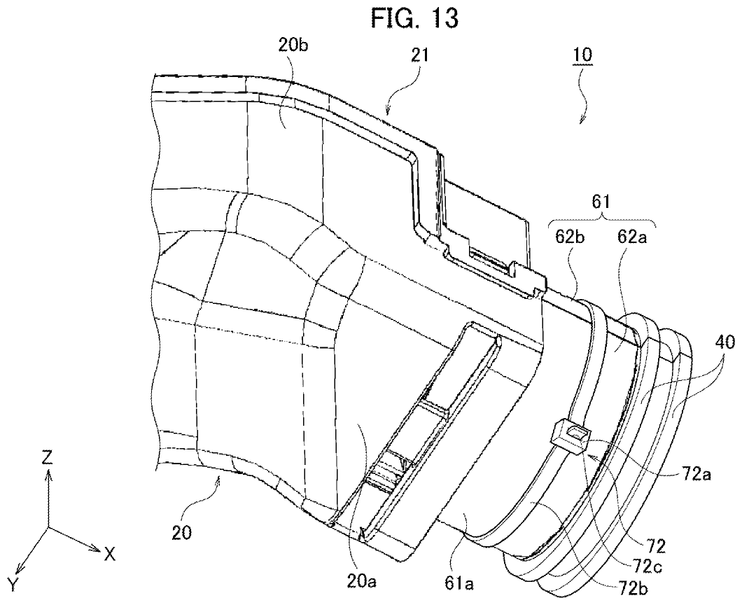

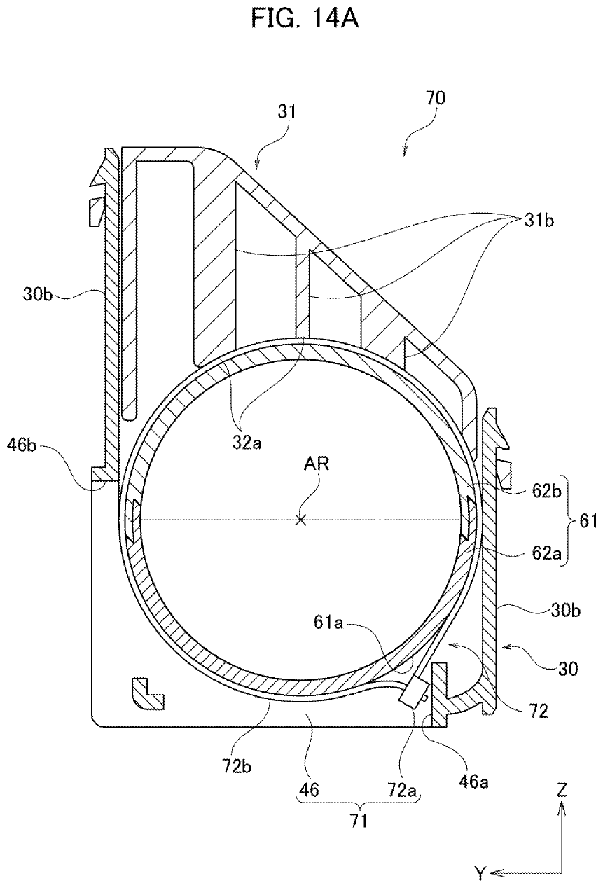

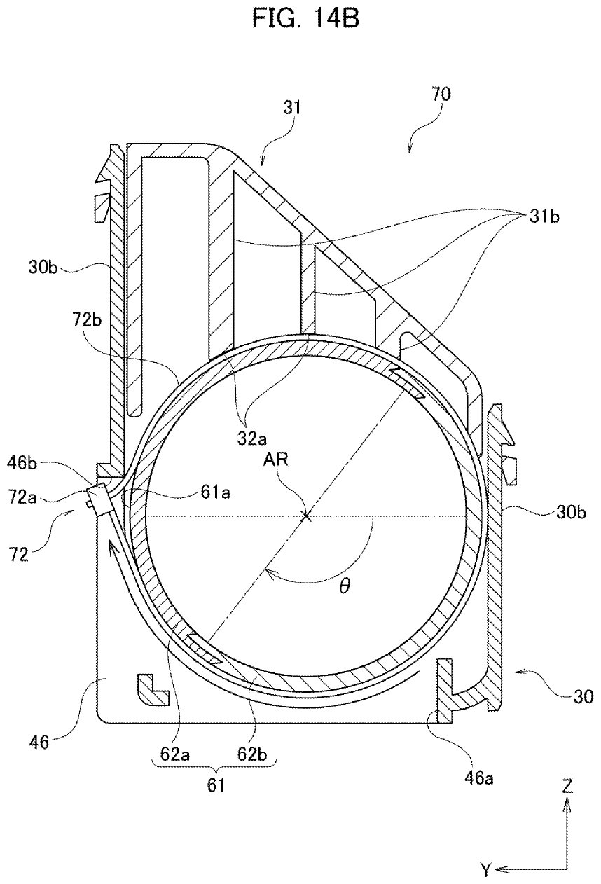

FIG. 13 is a perspective view of a bundling band 72 in the fourth embodiment. FIG. 14A is a cross-sectional view of the third restriction part 71 at the time of routing. FIG. 14B is a cross-sectional view of the third restriction part 71 at the time of vehicle assembly. As in FIGS. 10A and 10B of the first embodiment, FIGS. 14A and 14B are diagrams which correspond to XA-XA of FIG. 5A and are cut in the YZ plane at the position including the restriction groove 46,

The protector 1 according to the present embodiment includes a cylindrical body coupling part 70 in place of the cylindrical body coupling part 12 of the first embodiment. The cylindrical body coupling part 70 includes the inner cylindrical part 61 illustrated in the third embodiment as an example. However, the inner cylindrical part 61 of the present embodiment does not have a projection, such as the projection 45 described in the first embodiment or the projection 55 described in the second embodiment. The structure of the outer cylindrical part 32 in the cylindrical body coupling part 70 is the same as the corresponding structure of the cylindrical body coupling part 12.

In the cylindrical body coupling part 70, the bundling band 72 is attached to the outer peripheral part 61a of the inner cylindrical part 61 along the circumferential direction. The bundling band 72 includes a head part 72a and a band part 72b. The head part 72a supports one end of the band part 72b wound around the outer peripheral part 61a of the inner cylindrical part 61, and allows the other end of the band part 72b to be inserted and locked. When the band part 72b is inserted into a hole 72c provided in the head part 72a, the serrations formed in advance on the rear surface of the band part 72b are caught by claws (not illustrated) of the hole part 72c and fixed to the head part 72a without loosening. The bundling band 72 is then attached to the outer peripheral part 61a such that the head part 72a is disposed at the position where the projection 45 is provided in the first embodiment. That is, the third restriction part 71 is configured of the head part 72a of the bundling band 72 and the restriction groove 46, in which the head part 72a functions in the same manner as the projection 45 in the first embodiment.

Thus, the protector 1 according to the present embodiment may include the bundling band 72 having the band part 72b wound around the outer peripheral part 61a of the inner cylindrical part 61 and the head part 72a which supports one end of the band part 72b and allows the other end of the band part 72b to be inserted and locked. The inner peripheral part 32a of the outer cylindrical part 32 may have the restriction groove 46 which stores a portion of the head part 72a and restricts the movement of the head part 72a in a certain range in the circumferential direction. The first end part 46a, which is one end part of the restriction groove 46, may be in the position where the head part 72a comes into contact with the first end part 46a when the rotation angle θ of the inner cylindrical part 61 is the first angle θ1. The second end part 46b, which is the other end part of the restriction groove 46, may be in the position where the head part 72a comes into contact with the second end part 46b when the rotation angle θ of the inner cylindrical part 61 is the second angle θ2.

In the present embodiment, the same effect can be achieved as that of the protector 1 according to the first embodiment. In addition, since the structure of the cylindrical part is the same as that of the inner cylindrical part 61 in the third embodiment, and the bundling band 72 is attached to the entire outer peripheral part 61a of the inner cylindrical part 61, the deviation, inclination or unintentional deformation between the first semi-cylindrical part 62a and the second semi-cylindrical part 62b can be further suppressed. Further, the bundling band 72 is easily attached to and detached from the inner cylindrical part 61. Therefore, by appropriately changing the position of the head part 72a on the outer peripheral part 61a according to the use at the time of routing or vehicle assembly, the range in which the rotation angle θ of the inner cylindrical part 61 is restricted can be adjusted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A protector assembled to a vehicle in a state in which a wire harness is penetrated, the protector comprising:
a first cylindrical body having a first body which stores a portion of the wire harness in a first region over an entire extension direction and a first cover which is attached to the first body in a first attachment direction so as to cover the first region; and
a second cylindrical body having a second body which at least stores a portion of the wire harness which is not stored in the first cylindrical body in a second region over an entire extension direction and a second cover which is attached to the second body in a second attachment direction so as to cover the second region; wherein
one end of the first cylindrical body in the extension direction is an inner cylindrical part formed into a cylindrical shape,
one end of the second cylindrical body in the extension direction is an outer cylindrical part which rotates the inner cylindrical part around an axis while holding the inner cylindrical part at an inner side thereof, and
a rotation angle of the inner cylindrical part changes between a first angle in which the first attachment direction is in a same position as the second attachment direction and a second angle in which the first attachment direction is not in a same position as the second attachment direction and which is in a posture when the first cylindrical part and the second cylindrical part are assembled to the vehicle.

2. The protector according to claim 1, wherein
one of an outer peripheral part of the inner cylindrical part or an inner peripheral part of the outer cylindrical part has a rib extending in a circumferential direction and projecting toward the other thereof,
the other of the outer peripheral part of the inner cylindrical part or the inner peripheral part of the outer cylindrical part has an engagement groove engaged with the rib in a rotational direction of the inner cylindrical part, and
the rib or the engagement groove of the inner cylindrical part is provided at a tip-end part of the inner cylindrical part in the extension direction.

3. The protector according to claim 1, wherein
one of the outer peripheral part of the inner cylindrical part or the inner peripheral part of the outer cylindrical part has a projection projecting toward the other thereof,
the other of the outer peripheral part of the inner cylindrical part or the inner peripheral part of the outer cylindrical part has a restriction groove which stores a portion of the projection and restricts a movement of the projection in a certain range in the circumferential direction,
a first end part, which is one end part of the restriction groove, is in a position where the projection comes into contact with the first end part when the rotation angle of the inner cylindrical part is the first angle, and
a second end part, which is the other end part of the restriction groove, is in a position where the projection comes into contact with the second end part when the rotation angle of the inner cylindrical part is the second angle.

4. The protector according to claim 3,
wherein the second end part has a projection receiving portion in which a portion of the projection is fitted when the projection comes into contact with the second end part.

5. The protector according to claim 1, wherein
the inner cylindrical part is a combination of a first semi-cylindrical part which is a part of the first body and a second semi-cylindrical part which is a part of the first cover,
a first side end part of the first semi-cylindrical part has a notch part on an inner circumferential side or an outer circumferential side along a center of an axis of the inner cylindrical part such that a portion thereof enters an interior of a cylindrical wall along the circumferential direction,
a second side end part of the second semi-cylindrical part has a shape symmetrical to the first side end part in the circumferential direction, and
a portion of the second side end part is engaged with the notch part of the first side end part, and a portion of the first side end part is engaged with a notch part of the second side end part.

6. The protector according to claim 5, further comprising:
a bundling band including a band part wound around an outer peripheral part of the inner cylindrical part and a head part which supports one end of the band part and allows the other end of the band part to be inserted and locked, wherein
an inner peripheral part of the outer cylindrical part has a restriction groove which stores a portion of the head part and restricts a movement of the head part in a certain range in a circumferential direction,
one end part of the restriction groove in the circumferential direction is in a position where the head part comes into contact with the one end part when the rotation angle of the inner cylindrical part is the first angle, and
the other end part of the restriction groove in the circumferential direction is in a position where the head part comes into contact with the other end part when the rotation angle of the inner cylindrical part is the second angle.
